(19) United States
(12) Patent Application Publication
(10) Pub. No.: US 2006/0277939 A1
(43) Pub. Date: Dec. 14, 2006

(54) Refrigerated display and dispensing assembly

(76) Inventors: Petrue M.L.P. Beks, Heimond (NL); Richard John Birkett, Bedford (GB); Martinus Johannes, Petrus Janssen, Liessel (NL); Wilhelmus A.T. Uijen, Del. Cuauhtemoc (MX); Roland Thijs Vos, Rome (IT)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/550,639

(22) PCT Filed: Mar. 18, 2004
(86) PCT No.: PCT/EP04/02851

§ 371 Date: Jul. 10, 2006

(30) Foreign Application Priority Data
Mar. 24, 2003 (EP) 03251839.1

(51) Int. Cl. F25D 19/02; B67D 5/62

(52) U.S. Cl. 62/448; 62/389

(57) ABSTRACT

A display and dispensing assembly for use in combination with a freezer cabinet (1) which has an internal temperature T1, said display and dispensing assembly comprises (a) a housing (10) located externally of the freezer cabinet (b) a chamber (11) within the housing in which products can be stored and from which they can be dispensed, said products being stored at a temperature of T2 which is higher than T1 (c) first heat transfer means (18) within the housing (d) second heat transfer means (20) intended to be placed inside the freezer cabinet (e) means (19) for circulating a heat transfer fluid through the first and second heat transfer means.

The present invention relates to display and dispensing cabinets in which products which have to be stored at below ambient temperature such as ice cream, frozen food and chilled beverages are displayed and from which they are dispensed to the consumer. Such cabinets are well known and can be found in retail outlets around the world. Many such cabinets however are designed so that the temperature within them remains at one substantially constant value at any point within the cabinet. Such cabinets are therefore only suitable for displaying and dispensing products which have the same storage requirements. Many ice cream products must be stored at around −18° C. or less but this temperature is too low for some products such as soft ice creams which must be stored at around −12° C. if they are to be consumable as soon as they are removed from the cabinet. A solution to this problem would be to provide a further cabinet for the products that require to be stored at the higher temperatures. This is not however always practical as the retail outlet may not have sufficient room for the further cabinet. Also the further cabinet will have to be provided with its own refrigeration means to keep the contents at the required temperature. This increases the capital cost of the cabinet and increases the amount of power that is needed to run both cabinets. In many parts of the world the ice cream business is seasonal with more sales being made in the warmer seasons. If the installed cabinets within a retail outlet are large enough to meet the demand in the warmer seasons they will be too large to service the lower demand that exists at other times of the year. What is required therefore is a way of displaying and dispensing products that must be stored at below ambient temperature that allows products having different storage requirements to be sold together, which does not require the capital expenditure and the space of a further cabinet and which enables extra capacity to be provided at times when demand is greatest.

The present invention therefore provides display and dispensing assembly for use in combination with a freezer cabinet which has an internal temperature T1, said display and dispensing assembly comprising

(a) a housing located externally of the freezer cabinet

(b) a chamber within the housing in which products can be stored and from which they can be dispensed, said products being stored at a temperature of T2 which is higher than T1

(c) first heat transfer means within the housing

(d) second heat transfer means intended to be placed inside the freezer cabinet

(e) means for circulating a heat transfer fluid through the first and second heat transfer means.

Preferably the first heat transfer means comprises pipework in the chamber through which the heat transfer fluid is pumped. The pipework may surround the sides of the chamber. Preferably the second heat transfer means is connected to the first heat transfer means by flexible tubes that pass over or through a side wall of the freezer cabinet. The second heat transfer means may comprise pipework housed in a casing of a thermally conductive material. The casing may contain a eutectic material, preferably a eutectic material that has a freezing point in the range −10° to −17° C. Suitable eutectic materials include monopropyleneglycol or friogel. The use of the eutectic material in the casing ensures that the temperature in the freezer cabinet does not rise to an unacceptable value if products having a temperature above their desired storage temperature are placed in the chamber of the assembly of the present invention. For example if the chamber is intended to display and dispense chilled beverages in bottles or cans, the bottles or cans may be placed in the chamber at ambient temperature and so they will need to be cooled down to the desired storage temperature. Because of the presence of the eutectic material the heat extracted from these beverages does not result in a rise in temperature within the freezer cabinet.

The invention will be illustrated by the following description of embodiments thereof given by way of example only. The description has reference to the accompanying drawings in which:

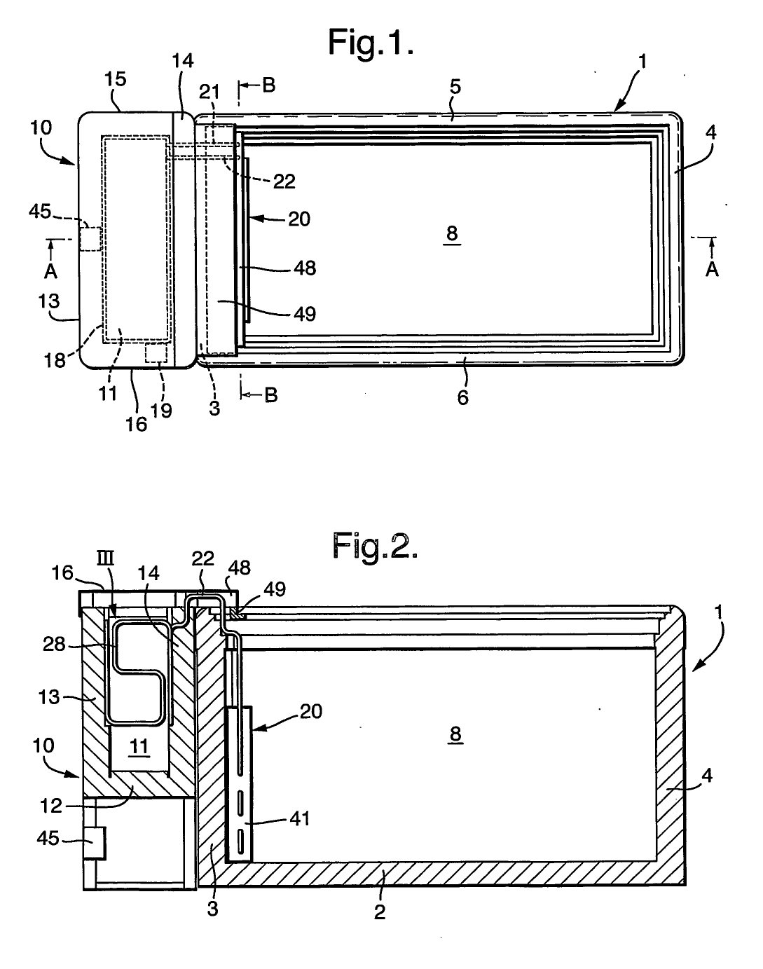

FIG. 1 is a plan view from above of a freezer cabinet and a display and dispensing assembly of the present invention,

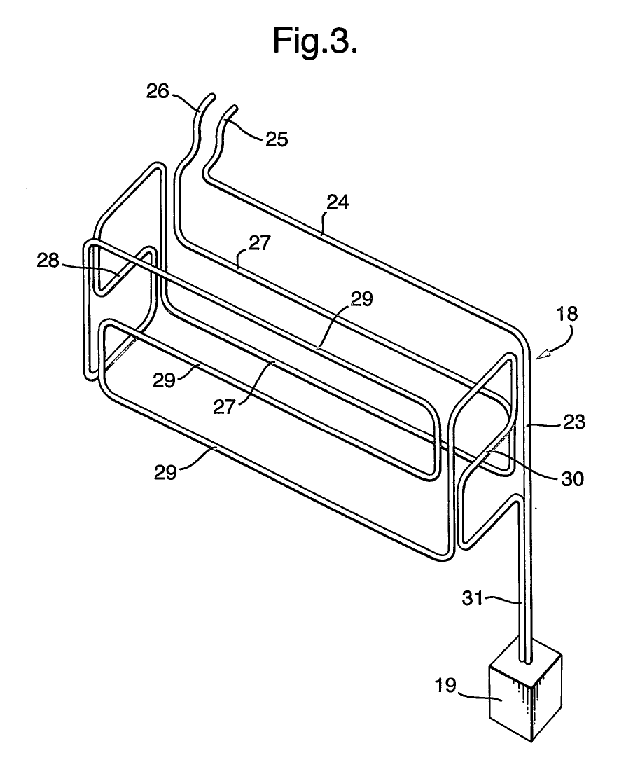

FIG. 2 is a cross-sectional view of the cabinet and assembly of FIG. 1 taken from the side and viewed along the line A-A in FIG. 1,

FIG. 3 is a schematic diagram showing the arrangement of tubing within the assembly of the present invention taken in the general direction indicated by the arrow III in FIG. 2,

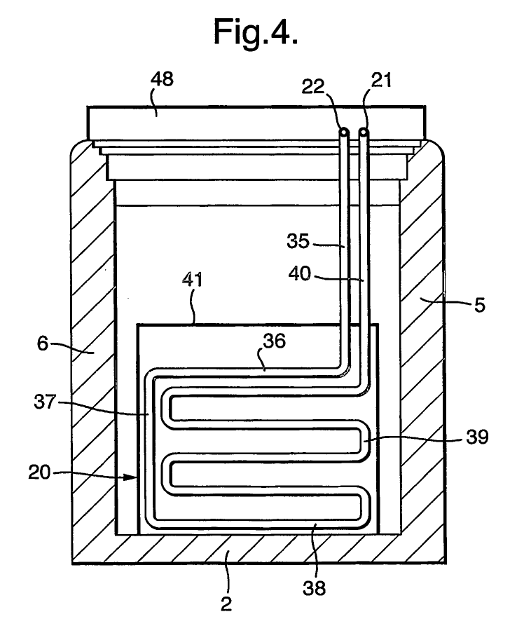

FIG. 4 is cross-sectional view taken along the line B-B in FIG. 1

As shown in FIGS. 1 and 2, an open top freezer cabinet 1 has a base 2, upstanding end walls 3,4 and upstanding side walls 5,6. The upper extremities of the side walls 3,4 and the side walls 5,6 define the open top of the cabinet. The interior 8 of the freezer cabinet is cooled in a known manner to a temperature of T1° C. If the freezer cabinet 1 is to be used to display and dispense many ice cream products the temperature T1 is preferably less then −16° C., more preferably less than −18° C. However freezer cabinets which are intended to store and dispense the so-called soft ice cream products may be at a temperature of around −10° C. Freezer cabinets of this type are well known and can be found in many retail outlets around the world.

The display and dispensing assembly of the present invention comprises a housing 10 containing a chamber 11 in which products can be stored and from which they can be dispensed. The housing 10 stands alongside the end wall 3 of the freezer cabinet 1. The compressor of the freezer cabinets refrigeration system is located at this end of the cabinet. The chamber 11 is defined by a base 12, side walls 13,14 and end walls 15,16. The base 12, side walls 13,14 and ends walls 15,16 contain thermal insulating material, for example polyurethane foam, to reduce heat transfer through the walls. A lid 16 is hingedly attached to the top of the side wall 14. The lid provides access to the interior of the chamber 11 when it is required to place products in the chamber or to dispense products from the chamber. The lid 16 may be transparent so that the consumer can see the products in the chamber. The chamber is cooled by the passage of heat transfer fluid though pipework 18 attached to the inner surface of the side walls 13,14 and the end walls 15,16 of the chamber 11 for example by spot welding and/or by the use of a thermally conducting material such as themopasta. The pipework 18 forms part of the first heat transfer means of the present invention. The heat transfer fluid is driven round the pipework 18 by a pump 19. The heat transfer fluid is also pumped through second heat transfer means 20 placed in the interior 8 of the freezer cabinet 1. The pipework 18 and the second heat transfer means 20 are connected by flexible pipes 21,22. The heat transfer fluid is a fluid having a freezing point below the temperature at which the interior of the freezer cabinet is to be maintained. A suitable heat transfer fluid is a mixture of potassium formate and water having a freezing point of around −30° C. (Temper −30)

The arrangement of the pipework 18 is shown schematically in FIG. 3. The heat transfer fluid is driven from the pump 19 up a vertically disposed tube 23, along a horizontally disposed tube 24 Attached to the inside of the side wall 14 and through an outlet 25 which is connected to the flexible pipe 22. The heat transfer fluid then passes through the second heat transfer means as will be described hereinafter and returns to the pipework 18 through inlet 26 connected to the flexible pipe 21. The fluid then passes through serpentine tube 27 on the side wall 14, through generally S-shaped tube 28 on end wall 15, through serpentine tube 29 on side wall 13 and through generally S-shaped tube 30 on end wall 16 before passing through tube 31 and returning to pump 19.

The heat transfer fluid passes through the flexible pipe 22 into the second heat exchange means 20 which is to be located within the freezer cabinet 1. The flexible pipe 22 is connected to a vertically disposed tube 35 through which the heat exchange fluid passes into the second heat exchange means 20. The heat exchange fluid then passes into a horizontally disposed tube 36, a vertically disposed tube 37, a lower horizontally disposed tube 38, a serpentine tube 39 and leaves the second heat exchange means 20 through a vertically disposed tube 40 which is connected to the flexible pipe 21. The tubes 36,37,38,39 are housed in a casing 41 made of a heat conducting material such as a metal. The vertically disposed tubes 35,40 extend upwardly out of the casing 41 as can be seen most clearly in FIG. 4. The casing is filled with a eutectic material for example a eutectic material having a freezing point in the range −10° to −17° C. such as monopropylene glycol or friogel. The casing 41 is placed inside the freezer cabinet 1 with its surface in close contact with the inside of the wall 3 of the freezer cabinet so as the ensure good thermal transfer between the wall 3 of the freezer cabinet and the second heat exchange means 20. The casing 41 may be provided with magnets to hold it in contact with the wall 3.

As the heat exchange fluid passes through the second heat exchange means 20 it is cooled and as it passes through the first heat exchange means it cools the chamber 11 and anything that is inside the chamber. A thermostat control means 45 detects the temperature inside the chamber 11 and controls the circulation of the heat transfer fluid through the first and second heat exchange means to give the desired temperature T2 in the chamber by switching the pump 19 on and off. The thermostat control means 45 also comprises a probe (not shown) which detects the temperature inside the chamber 11. The probe may be located inside the chamber or on the outside of the chamber in a position where it can give an accurate value for the temperature within the chamber 11. If the product to be stored and dispensed from the chamber 11 is for example a soft ice cream the temperature T2 within the chamber may be in the range −6° to −15° C. preferably in the range −6° to −12° C. whereas if the product is for example a chilled beverage the temperature T2 should be in the range +2 to +8° C. preferably around +4° C. The pump 19 preferably circulates the heat transfer fluid at a low speed for example 50 to 700 litre/hour, preferably 150 to 300 litre/hour. A fan (not shown) may be placed inside the chamber 11 to circulate the air within the chamber 11 to ensure that the temperature T2 throughout the chamber 11 is substantially constant.

The freezer cabinet 1 may conventionally be fitted with two sliding lids (not shown) which slide from side to side to allow access to the interior 8 of the freezer cabinet 1. When in the fully closed position the sliding lids abut the upper part of the end walls 3,4 of the cabinet 1 so that there are no gaps through which air can circulate to cause unacceptable heat losses. The flexible pipes 21,22 would prevent the sliding lids from closing completely allowing air to circulate and causing heat losses. The housing 10 is provided with an overhanging cover 48 which covers the flexible pipes 21,22 and extends over the end wall 3 of the cabinet 1 when the housing 10 is placed alongside end wall 3 as shown in the Figures. The cover 48 is provided with a seal 49 of a similar shape to that of the upper part of the end wall 3 so that when the sliding lid is in its closed position it abuts against the seal 49 preventing any gaps. In the known cabinets a seal is also provided at the central overlap of the two sliding doors to prevent air entering the freezer cabinet between the two lids. These seals will need to be moved or replaced as a result of the displacement of the overlapping parts of the lids following the fitting of the assembly of the present invention. These above-described adaptations to the sliding lids will not be necessary if the tubes 21,21 connecting the first and second heat exchange means pass through the end wall 3 rather then over the top of it.

In use the housing 10 is placed against the side wall 3 of the freezer cabinet 1 and the second heat transfer means 20 is placed inside the interior 8 of the freezer cabinet 1. The housing may be free standing with its base on the floor adjacent to the freezer cabinet or it may be hung over the side by brackets which rest on the top of the end wall 3 of the freezer cabinet and have downwardly extending portions which contact the inside of the end wall 3 of the freezer cabinet to hold the housing adjacent the end wall 3 of the cabinet. The lateral position of the downwardly extending portions may be adjustable so that the housing can be attached to freezer cabinets having walls 3 of different thickness. An adjustable foot or feet (not shown) may be provided so that the height of the housing may be changed to match that of the freezer cabinet to which it is to be attached. The use of the brackets and the flexible connection between the first and second heat exchange means enable the housing to be fitted and removed easily as required After the housing has been attached to the freezer cabinet, the pump is operated to circulate the heat transfer fluid through the first and second heat exchange means to cause the temperature in the chamber 11 to be reduced to the desired temperature T2 for the product to be stored therein. The use of the assembly of the present invention allows the simultaneous storing and dispensing of products without the need for installing a second freezer cabinet which involves a larger capital cost and takes up more space which may not be readily available in many retail outlets. As the assembly of the present invention does not have its own refrigeration means it is cheaper to produce and run and when the demand for the chilled or frozen products it contains is less the assembly can be readily removed by the operator of the retail outlet and stored until it is needed again.

1. A display and dispensing assembly for use in combination with a freezer cabinet which has an internal temperature T1, said display and dispensing assembly comprising
(a) a housing located externally of the freezer cabinet
(b) a chamber within the housing in which products can be stored and from which they can be dispensed, said products being stored at a temperature of T2 which is higher than T1
(c) first heat transfer means within the housing
(d) second heat transfer means intended to be placed inside the freezer cabinet
(e) means for circulating a heat transfer fluid through the first and second heat transfer means,
and wherein the assembly is removable from the freezer cabinet.

2. A display and dispensing assembly as claimed in claim 1 wherein the first heat transfer means comprises pipework around the chamber through which the heat transfer fluid is pumped

3. A display and dispensing assembly as claimed in claim 1 wherein the second heat transfer means is connected to the first heat transfer means by flexible tubes that pass over a side wall of the freezer cabinet.

4. A display and dispensing assembly as claimed in claim 1 wherein the second heat transfer means may comprise pipework housed around a casing of a thermally conductive material.

5. A display and dispensing assembly as claimed in claim 4 wherein the casing contains a eutectic material

6. A display and dispensing assembly as claimed in claim 5 wherein the eutectic material has a freezing point in the range −10 to −17° C.

7. A display and dispensing assembly as claimed in claim 1 wherein the temperature T1 is less than −16° C.

8. A display and dispensing assembly as claimed in claim 7 wherein the temperature T1 is less than −10° C.

9. A display and dispensing assembly as claimed in claim 1 wherein the temperature T2 is in the range −2° to −15° C.

10. A display and dispensing assembly as claimed in claim 9 wherein the temperature T2 is in the range −6° to −12° C.

11. A display and dispensing assembly as claimed in claim 1 wherein the temperature T2 is in the range +2° to +8° C.

12. A display and dispensing assembly as claimed in claim 11 wherein the temperature T2 is around +4° C.
